(19) United States
(12) Patent Application Publication
(10) Pub. No.: US 2017/0148057 A1
(43) Pub. Date: May 25, 2017

(54) Advertising Workflow to Increase Click-Through Rates

(71) Applicant: Adobe Systems Incorporated, San Jose, CA (US)

(72) Inventors: Shrinidhi Karanth Parameshwar, Bengaluru (IN); Dwight O. Rodgers, Mountain View, CA (US)

(21) Appl. No.: 14/949,463

(22) Filed: Nov. 23, 2015

(51) Int. Cl. G06Q 30/02; H04L 29/06; H04L 29/08

(52) U.S. Cl. CPC G06Q 30/0257; H04L 67/02; H04L 65/601

(57) ABSTRACT

Various implementations provide improved advertisement workflow techniques designed to increase click-through rates in the context of a digital medium environment. When content, such as streaming video, is received and has an associated advertisement, an option can be provided to enable the user to defer viewing of the advertisement. If the user selects the defer viewing option, the advertisement is placed in a deferred advertisement queue for later viewing and the user can proceed directly to consuming their content. The user can then choose to view deferred advertisements at any time that is convenient to the user.

### BACKGROUND

Having to watch a video advertisement on a computing device prior to consuming content, such as a streaming video, can be annoying to some consumers. This is particularly the case if the user is very interested in the content. Oftentimes users can shorten the video advertisements by choosing available options such as a “skip” button after 5 or 10 seconds, or by answering a question on the advertisement. Sometimes, however, an option to shorten the video advertisement is not provided and, frustratingly, the user must wait for the video advertisement to fully run.

This less than desirable situation affects many different parties including content publishers, advertisers, and end-users. Content publishers are affected because the content is not consumed in an uninterrupted context in which the user can dedicate their full attention to the content. Advertisers are affected because their advertisements are seen as a distraction to the content viewing experience or can often be skipped. End-users are affected because their perceived content viewing experience is disjointed and annoying. And, while ad views or impressions may increase, click through rates can suffer because viewers may not watch or click the video advertisement because they are eager to get back to watching the content. “Click through rate” in advertising refers to the number of users who click on a specific link out of the total users who view an advertisement, and measures the success of an online advertising campaign.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

Various implementations provide improved advertisement workflow techniques designed to increase click-through rates in the context of a digital medium environment. When content, such as streaming video, is received and has an associated advertisement, an option can be provided to enable the user to defer viewing of the advertisement until a later time. If the user selects the defer viewing option, the advertisement is placed in a deferred advertisement queue for later viewing and the user can proceed directly to consuming their content. The user can then choose to view deferred advertisements at any time that is convenient to the user.

In one or more implementations, a digital medium environment includes a computing device having an advertising workflow application that performs advertisement workflow management. An improved advertising workflow method receives content having an associated advertisement and provides an option to defer viewing of the advertisement until a later time. Responsive to determining that the option to defer viewing of the advertisement has been selected, viewing of the advertisement is deferred.

In one or more other implementations, a digital medium environment includes a computing device having an advertising workflow application that performs advertisement workflow management. One or more computer-readable storage media comprise instructions that are stored thereon that implement the advertising workflow application which, responsive to execution by the computing device, performs improved advertising workflow operations that include receiving content having an associated advertisement and providing an option to defer viewing of the advertisement until a later time. Responsive to determining that the option to defer viewing of the advertisement has been selected, viewing of the advertisement is deferred by: preparing a notification associated with the advertisement to be deferred; placing the notification in a notification panel associated with the computing device; and making an entry that represents the advertisement in a deferred advertisement queue.

In one or more other implementations, a system implemented in a digital medium environment includes a computing device having an advertising workflow application to perform advertisement workflow management. The system comprises a processing system and one or more computer readable media storing instructions executable via the processing system to implement an advertising workflow application. The advertising workflow application is configured to perform operations comprising receiving selection of an option to defer viewing of an advertisement that is associated with content that is to be consumed on the computing device and determining whether a cancelable notification threshold is met. The cancelable notification threshold pertains to notifications that serve as a reminder that advertisement viewing has been deferred. The cancelable notifications can be visually hidden by a user. Responsive to the cancelable notification threshold not being met, a notification associated with the advertisement is placed in a cancelable notification area of a user interface. Responsive to the cancelable notification threshold being met, one or more notifications are placed in a non-cancelable notification area of the user interface. The non-cancelable notifications cannot be visually hidden by a user.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a digital medium environment in an example implementation that is operable to employ techniques described herein.

FIG. 2 illustrates an example advertising workflow application and its component parts in accordance with one or more implementations.

FIG. 3 illustrates an example digital medium environment including a computing device in accordance with one or more implementations.

FIG. 4 illustrates an example digital medium environment including a computing device in accordance with one or more implementations.

FIG. 5 is a flow diagram depicting an example procedure in accordance with one or more implementations.

FIG. 6 illustrates an example digital medium environment including a computing device in accordance with one or more implementations.

FIG. 7 is a flow diagram depicting an example procedure in accordance with one or more implementations.

FIG. 8 illustrates an example digital medium environment including a computing device in accordance with one or more implementations.

FIG. 9 is a flow diagram depicting an example procedure in accordance with one or more implementations.

FIG. 10 illustrates an example digital medium environment including a computing device in accordance with one or more implementations.

FIG. 11 illustrates an example system including various components of an example device that can be employed for one or more search implementations described herein.

### DETAILED DESCRIPTION

Overview

As noted above, having to watch a video advertisement before or during a content consuming experience can be annoying to many users. While the user may, in some instances, be able to skip through the video advertisement using a “skip” button, they still must watch a portion of the video advertisement for a predefined period of time, such as 5 to 10 seconds. If the “skip” button is selected, typically the user does not have to watch the entire advertisement at all. For a user who simply wishes to consume content, having to watch 5 or 10 seconds of the video advertisement can be annoying and can degrade the content consuming experience. If the advertisement is skipped, however, the advertiser does not get the benefit of having their entire advertisement viewed by a user.

The various implementations improve upon this forced advertisement model by providing an advertising workflow which allows users to defer video advertisements and watch the video advertisements on their computing device at their own convenience some time later. That is, the users are not initially forced to watch an advertisement for a predefined period of time before consuming content. This allows for much better advertisement engagement because the user can choose when to watch a particular advertisement and, thus, be more focused on the advertisement. The content consuming experience is also enhanced because the user can consume their content without the added interruption of having to watch an advertisement for a predefined period of time. In addition, advertisers will receive more visits to their webpage or applications in an application store. In addition, the advertising server will experience an increase in ad revenue as the click through rates of ads will increase substantially. This is because rather than skipping an advertisement, the user has agreed to defer viewing of the advertisement to a later date. Content publishers will also benefit because their content will be watched with less interruption and revenue will increase from the advertisements because of the increase in click through rates.

In one or more implementations, a digital medium environment includes a computing device having an advertising workflow application that performs advertisement workflow management. An improved advertising workflow method receives content having an associated advertisement and provides an option to defer viewing of the advertisement until a later time. Responsive to determining that the option to defer viewing of the advertisement has been selected, viewing of the advertisement is deferred.

As an example, assume that Dad has his mobile device handy and wishes to show his guitar-playing son Max the new Joe Satriani video. Dad really does not wish to show Max a video advertisement, prior to the video, which has no context for Max. Rather, Dad just wishes to show Max the new video. In this case, Dad may browse to a link to the video, click the link and cause his video playing application to be launched. Prior to playing the Satriani video, a video advertisement begins to play. In response to receiving the advertisement, Dad's device can present a user interface instrumentality to enable Dad to defer viewing of the advertisement until a later date. That is, by selecting the user interface instrumentality when the advertisement begins to play, the advertisement can be designated, as by being placed into a deferred advertisement queue, as one that is to be viewed at some point in the future. In addition, an advertisement notification can be pushed to the device's notification panel, where a visual reminder of the advertisement will remind Dad that he has an advertisement to view. In this manner, the advertisement need not be viewed presently. Rather, viewing can be deferred until a time that is convenient for Dad.

In some implementations, the user can opt to view the advertisement in which case the advertisement will be played in the usual way. If, however, the user opts to defer an advertisement, the advertisement can be stopped immediately and the content can play or resume instantly. Once the user indicates that the advertisement is to be deferred, the advertisement or a representation thereof, such as a link and other related information, is placed onto a deferred advertisement queue. The deferred advertisement queue is used to hold advertisements that have been deferred so that the user can view the advertisements at a later date. In addition, an advertisement notification can be generated to remind the user that they have deferred viewing of the advertisement. In various implementations, the other related information placed on the deferred advertisement queue can include tracking URLs and a click URL. The click URL is pinged by the video player when the user clicks on an advertisement. The tracking URLs are a list of URLs that are pinged whenever the video advertisement is played for certain time. For example, typically, there will be five tracking URLs, one each for 0%, 25%, 50%, 75% and 100% viewing progress. So, when the advertisement starts playing, the video player should ping the 0% tracking URL. When the advertisement is played 25% of the duration, the 25% tracking URL is pinged, and so on. The advertising server will know how much advertisement was viewed based on the tracking pings. The advertisement notification can then be handled in a number of different ways.

A first way to handle the notification is to place the notification in the device's notification panel. The device's “notification panel” is the location where most if not all notifications of the device are shown or displayed. For example, when an SMS message or e-mail is received, the notification panel shows the user that there is an incoming SMS message or e-mail, along with a partial text of the incoming SMS message or e-mail. The notification panel may be referred to by different names in different products such as, for example, a “notification bar” or a “notification center”. Whatever the name, the concept is the same or similar—to provide a notification of some incoming content with perhaps a small excerpt or representation of that content. When such a notification is selected, such as by being tapped or otherwise chosen by the user, the application that provided the notification is typically launched or otherwise activated and the corresponding message can be viewed.

Alternately or additionally, a second way to handle the notification is to associate the notification with the application that would normally play the associated video advertisement, e.g., a video player application. In this manner, the next time the user launches the video player application, they are provided with an option to view the advertisements which have been queued up in association with the video player application.

It is to be appreciated and understood that the notifications can be handled in either or both of the ways mentioned above. In a situation where a notification is placed in the device's notification panel, the notification panel can display a small amount of text regarding the advertisement, an image banner based on the advertisement, and the like. In some instances, the notification can be marked or otherwise indicated as “cancelable.” A cancelable notification is one that has a visual representation on the device, but which representation can be visually hidden by the user. For example, in at least some implementations, a cancelable notification includes a user interface instrumentality, such as a “clear” button, to enable the user to select and thereby cause the notification to visually disappear. Advertisements associated with cancelable notifications can, in at least some instances, still be maintained in the deferred advertisement queue for later viewing, even though the notification was hidden.

In some implementations, if the number of cancelable notifications reaches a certain threshold, then one or more of the notifications can be added to the notification panel as “non-cancelable” notifications. Alternately or additionally, time can also be used as a metric to determine when to transition a cancelable notification to a non-cancelable notification. For example, if a deferred advertisement has a notification that has resided as a cancelable notification for 10 days or a certain number of days which can be configured by the video player, its associated notification can be transitioned to a non-cancelable notification. A non-cancelable notification is one that cannot be visually hidden by the user. This provides a constant visual reminder to the user that there are a number of advertisements that need to be viewed and that the user committed to viewing the advertisements earlier. The user may still view content at this point.

In some implementations, if the number of deferred advertisements which have non-cancelable notifications in the notification panel exceeds a certain threshold, then the deferred advertisement option will not be shown to the user. Not showing deferred advertisement option can be implemented by monitoring the total number of deferred advertisements. The advertisements can be deferred while watching content on various websites, various browsers, various players, or various applications. In other implementations, not showing deferred advertisement option can be implemented by monitoring deferred advertisements on a per website basis, per player basis, per publisher basis, and the like. As such, the user will not have the option to defer any additional advertisements and will have to watch at least some of the advertisements in order to be able to consume their content.

In some implementations in which the user has deferred viewing advertisements and, instead, consumed their video content, upon conclusion of the video content, the user can be provided an option to view any or all of the deferred advertisements that reside in the deferred advertisement queue. If the user watches a video advertisement, that video advertisement will be removed from the notification panel and also from the deferred advertisement queue.

In some implementations, the state of the notification panel and deferred advertisement queue is maintained across device restarts and video player restarts. That is, if multiple advertisements reside in the notification panel and deferred advertisement queue and the video player is closed or the device is restarted, those advertisements will still reside in the notification panel and the deferred advertisement queue. In this manner, the user will still be committed to watching the advertisements even though they restarted their video player or device. When the user restarts their device or video player, if the user does not select any advertisement in the notification panel, the user can be given an option to watch a few or all of the deferred advertisements just before the next content starts. Once he or she views a few advertisements which, in turn, reduce the advertisements in the deferred advertisement queue, the user will be allowed to watch the next content.

In some implementations, when the user chooses to view a particular advertisement, they can select the advertisement in the notification panel. They may do this in any suitable way such as by tapping or otherwise selecting a notification. When this happens, the video player application that pushed the notification is launched and the application plays the video advertisement. When the advertisement is played, the video player can notify the advertising server regarding the ad click so that the appropriate metrics maintained by the advertising server can be updated, such as updating the status of the ad from “not watched” to “watched.” Specifically, as noted above, in some implementations, when the advertisement is deferred, a URL to the advertisement is pushed to the deferred advertisement queue, along with tracking URLs and a click URL. When the user watches the video advertisement, the tracking URLs will be pinged by the video player at the appropriate time. In some implementations, there will be a tracking URL that needs to be pinged whenever the video advertisement playback starts, stops and also when the progress is at 0%, 25%, 50%, 75% and 100%. From these tracking pings, the advertising server knows which advertisement was played, how long the advertisement was played, and for how many times. The click URL is pinged when the user clicks on the advertisement. The tracking URLs and click URL will be unique for the advertisement that is served. So, from the tracking and click URLs, the advertising server knows the video session for which the advertisement was served. Once completely viewed, the advertisement can then be removed from the deferred advertisement queue.

In the following discussion, an example digital medium environment is first described that may employ the techniques described herein. Example implementation details and procedures are then described which may be performed in the example digital medium environment as well as other environments. Consequently, performance of the example procedures is not limited to the example environment and the example environment is not limited to performance of the example procedures.

Example Digital Medium Environment

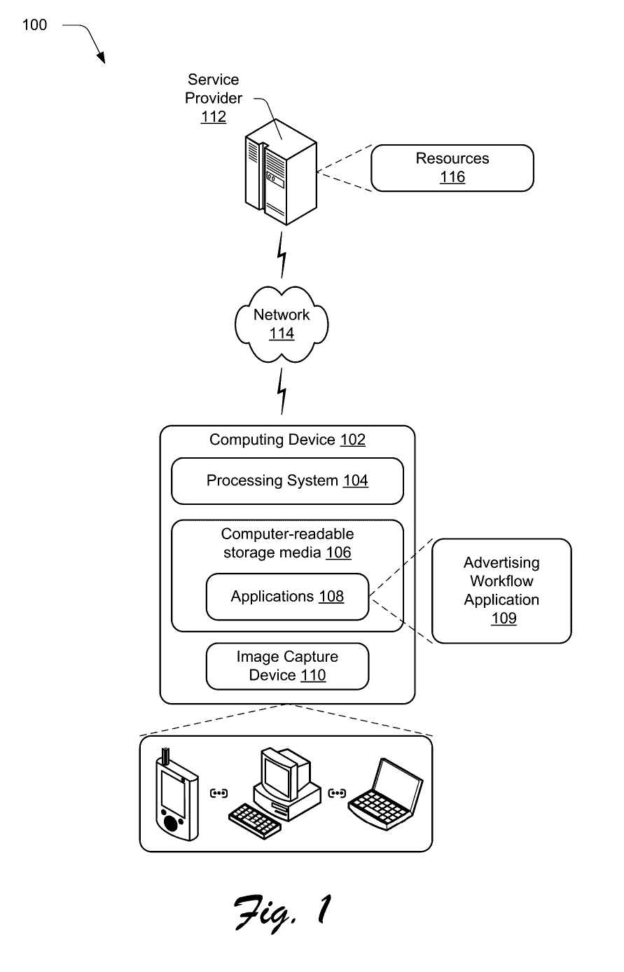

FIG. 1 is an illustration of a digital medium environment 100 in an example implementation that is operable to employ techniques described herein. As used herein, the term “digital medium environment” refers to the various computing devices and resources that can be utilized to implement the techniques described herein. The illustrated digital medium environment 100 includes a computing device 102 including a processing system 104 that includes one or more processing devices, one or more computer-readable storage media 106, and various applications 108 embodied on the computer-readable storage media 106 and operable via the processing system 104 to implement corresponding functionality described herein. In at least some implementations, applications 108 include an advertising workflow application 109. In some implementations, the advertising workflow application 109 is a standalone application. In other implementations, the advertising workflow application 109 is included as part of another application, such as a video playing application or system software such as a computing device's operating system. The advertising workflow application 109 is configured to process and manage notifications regarding advertisements that are provided in conjunction with content, such as streaming video content that is consumed on the computing device. The advertising workflow application 109 includes functionality that enables a user to defer viewing the advertisement until a later time. This permits the user to immediately consume their content in a generally uninterrupted manner while, at the same time, opting to defer viewing of an advertisement.

Applications 108 may also include a web browser which is operable to access various kinds of web-based resources (e.g., content and services). In at least some implementations, the applications include one or more video players, such as Adobe® Flash® Player, a YouTube™-type application, and the like. In at least some implementations, the applications 108 represent a client-side component having integrated functionality operable to access web-based resources (e.g., a network-enabled application), browse the Internet, interact with online providers, and so forth. Applications 108 further include an operating system for the computing device 102 and other device applications.

The computing device 102 may also, but need not, include an image capture device 110, such as a camera, that can capture images.

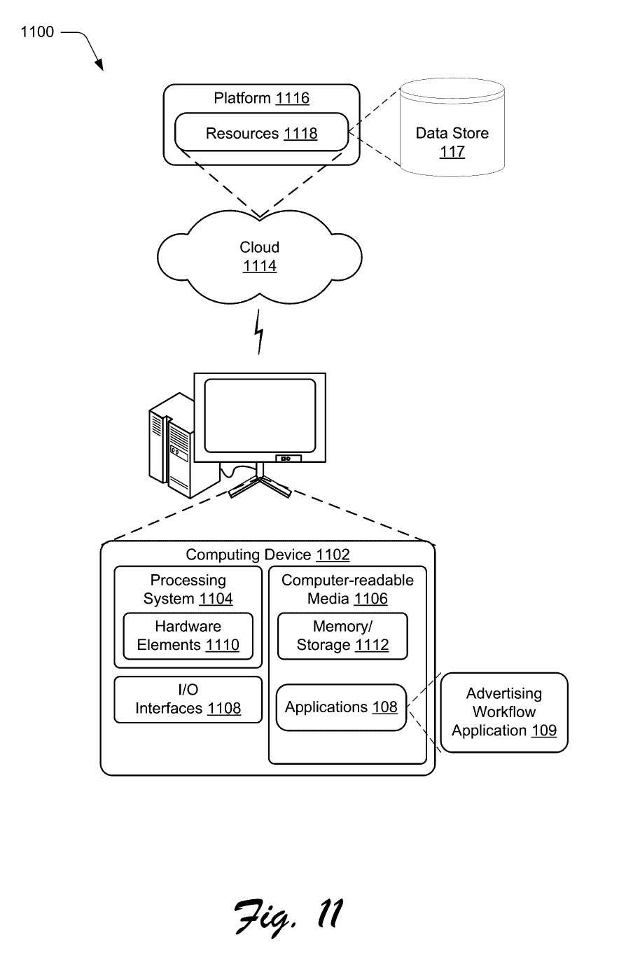

The computing device 102 may be configured as any suitable type of computing device. For example, the computing device may be configured as a desktop computer, a laptop computer, a mobile device (e.g., assuming a handheld configuration such as a tablet or mobile phone), a tablet, a camera, and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 11.

The digital medium environment 100 further depicts one or more service providers 112, configured to communicate with computing device 102 over a network 114, such as the Internet, to provide a “cloud-based” computing environment. Generally speaking, a service provider 112 is configured to make various resources 116 available over the network 114 to clients. In some scenarios, users may sign up for accounts that are employed to access corresponding resources from a provider. The provider may authenticate credentials of a user (e.g., username and password) before granting access to an account and corresponding resources 116. Other resources 116 may be made freely available, (e.g., without authentication or account-based access). The resources 116 can include any suitable combination of services and/or content typically made available over a network by one or more providers. Some examples of services include, but are not limited to, a notification service (such as one that sends various types of notifications to applications 108 and advertising workflow application 109), a content publisher service that distributes content to various computing devices, an advertising server service that provides advertisements to be used in connection with distributed content (including notifications regarding the advertisements), a web development and management service, a collaboration service, a social networking service, a messaging service, and so forth. Content may include various combinations of assets, video comprising part of an asset, advertisements, audio, multi-media streams, animations, images, web documents, web pages, applications, device applications, and the like.

Various types of input devices and input instrumentalities can be used to provide input to computing device 102. For example, the computing device can recognize input as being a mouse input, stylus input, touch input, input provided through a natural user interface, and the like. Thus, the computing device can recognize multiple types of gestures including touch gestures and gestures provided through a natural user interface.

Having considered an example digital medium environment, consider now a discussion of some example details of an advertising workflow application, for example the advertising workflow application 109, in accordance with one or more implementations.

Example Advertising Workflow Application

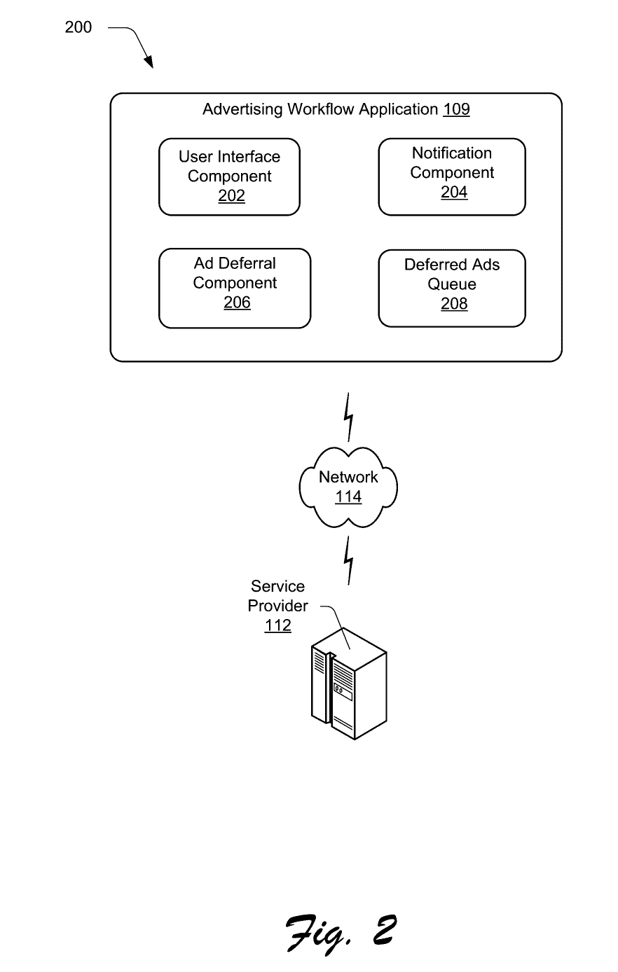

FIG. 2 illustrates a digital medium environment 200 that includes an example advertising workflow application 109. In this implementation, the advertising workflow application 109 includes a user interface component 202, a notification component 204, an advertisement deferral component 206, and a deferred advertisement queue 208. It is to be appreciated and understood, however, that the functionality of the advertising workflow application can be implemented by a remote entity, such as one or more servers in a cloud-based environment. When implemented using remote entity, in some embodiments, one or more components of the advertising workflow application 109 can be present on the remote entity or can be present at both the computing device 102 and the remote entity. In addition, the components present at the computing device 102 can perform syncing operations with the components present at the remote entity. The user interface component 202, notification component 204, advertisement deferral component 206, and deferred advertisement queue 208 work together to allow a user to receive content that has associated advertisements. The user interface component 202 allows the user to select the deferral option for advertisement which then causes the notification component 204 to generate a notification for advertisements that have been deferred. The notification reminds the user that an advertisement has been deferred for later viewing. The advertisement deferral component then places the advertisement or a representation of the advertisement on the deferred advertisement queue so that the user can later view the advertisement that has been deferred.

User interface component 202 is representative of functionality that provides a user interface with various user interface instrumentalities with which a user may interact. For example, the user interface component can provide a user interface instrumentality that is selectable by a user to consume content, such as streaming videos and the like. For example, in some implementations, when content is received, a video player application can be launched to play the content. When an associated advertisement is received and played, a user interface instrumentality in the form of a user-selectable button can be rendered on top of the advertisement to enable the user to select to defer viewing of the advertisement. If the user-selectable button is selected by the user, the advertisement can be placed on the deferred advertisement queue for later viewing. A notification associated with the deferred advertisement can also be generated. The user interface component can also provide a notification panel that can display the notifications regarding advertisements as described below in more detail. The notification panel, in some implementations, can include an area for non-cancelable notifications (which cannot be visually removed) and an area for cancelable notifications (which can be visually removed). The user interface component can also provide an instrumentality to enable a user to defer viewing of an advertisement that is received with or otherwise associated with content that is received by a user's computing device.

Notification component 204 is representative of functionality that processes and manages notifications associated with video advertisements that are received by the computing device. The notification component can work in conjunction with the user interface component to surface notifications to the user by way of the notification panel.

The advertisement deferral component 206 is representative of functionality that enables a user to select an advertisement for deferral. The advertisement deferral component includes, in at least some implementations, management functionality to detect advertisements that are received, as by monitoring for incoming advertisements from ad servers or outgoing requests for advertisements, and manage the status of advertisements that have been deferred. For example, the advertisement deferral component can manage whether an advertisement's notification is cancelable or non-cancelable. This component can also track the state of the various notifications. For example, the advertisement deferral component can manage and track whether various thresholds have been met which might cause a notification to be transitioned from a cancelable notification to a non-cancelable notification, examples of which are provided below.

The deferred advertisement queue 208 represents functionality that enables advertisements to be queued up for later viewing. The deferred advertisement queue can maintain a list of notifications and links associated with advertisements such that when a user eventually opts to view a particular advertisement, the link can be used to access the advertisement. Alternately or additionally, the deferred advertisement queue 208 can store the actual content of the advertisements which might have been previously received with content that has already been consumed by a user.

The digital medium environment 200 also includes network 114 and service provider 112 described above in detail.

Having considered an example advertising workflow application and its components, consider now an example user interface in accordance with one or more implementations.

Example User Interface

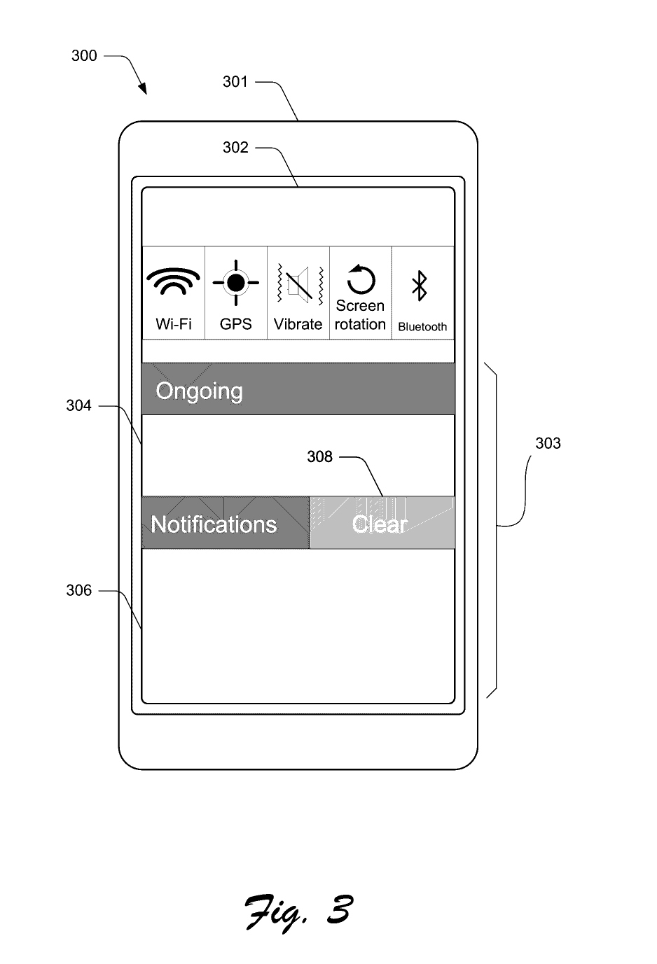

FIG. 3 illustrates an example digital medium environment 300 that includes a computing device 301 in the form of a mobile computing device. Computing device 301 includes a display 302 in which a user interface is shown. The user interface can be provided by a suitably configured component such as user interface component 202 (FIG. 2). The user interface includes various user interface instrumentalities with which a user may interact. This particular user interface includes a notification panel shown generally at 303. The notification panel displays various notifications for the user such as notifications that pertain to advertisements that are to be viewed by the user. In this particular example, the notification panel 303 includes separate areas within which notifications can be displayed.

A first of the areas is a non-cancelable notification area 304. The non-cancelable notification area is used to display notifications which cannot be visually removed. In this manner, the user is provided with a constant visual reminder of any notifications that appear within this area. A second of the areas is a cancelable notification area 306. The cancelable notification area is used to display notifications which can be visually removed. Specifically, in this particular example, a “clear” button 308 is provided that enables a user to visually remove or clear a notification that has been placed in the cancelable notification area 306. When the user has deferred viewing an advertisement, a notification associated with the deferred advertisement can be placed into cancelable notification area 306. By selecting the clear button 308, the visual notification is removed. Even though the notification is visually removed, the advertisement associated with the notification still remains in the deferred advertisement queue to enable the advertisement to be viewed later.

Having considered an example user interface, consider now how viewing an advertisement can be deferred and how deferred advertisements are represented in the user interface.

Deferring an Advertisement

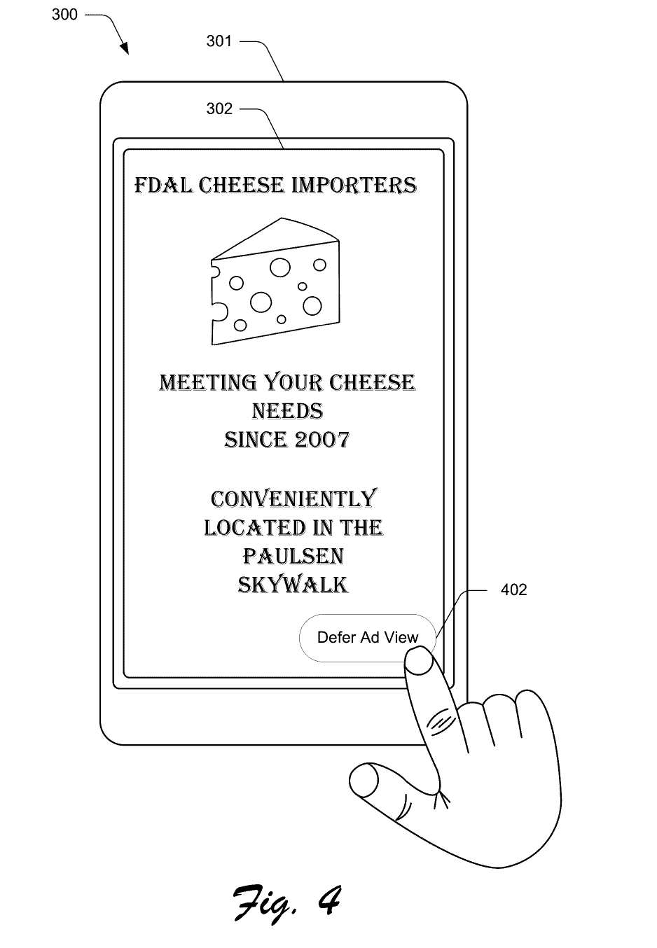

Often times when a user receives consumable content on their computing device, the content will be accompanied by, or be otherwise associated with one or more video advertisements that are to be played before the content is consumed. So, perhaps the user browsed to a video viewing service, such as Adobe Primetime, to select a multimedia video for viewing. In addition to receiving the multimedia video, the user's computing device may also receive one or more advertisements from an advertisement server, such as Adobe Auditude. When the advertising workflow application detects these advertisements, as through the advertisement deferral component 206, the advertising workflow application can provide the user with an option to defer viewing of the advertisement. The deferring option can be implemented in different ways. For example, in some implementations, the deferring option can be provided without necessarily playing the advertisement. That is, before the advertisement is played, a user interface instrumentality can be rendered to enable the user to opt to defer viewing the advertisement. Alternately, in some implementations, the deferring option can be provided contemporaneously while playing the advertisement. This can enable the user to immediately defer viewing the advertisement. As an example, consider FIG. 4 which uses like numerals from FIG. 3.

In this example, assume that a user has selected multimedia content for viewing and has received an advertisement along with the multimedia content. In this particular example, the advertisement is for “FDAL Cheese Importers” and includes a short 20 second video for this business. In addition to playing the advertisement, a user interface instrumentality in the form of a button 402 allows the user to defer viewing of the advertisement. In some implementations, as soon as the advertisement begins, button 402 is rendered over top of the advertisement to enable the user to immediately make a selection if they wish to defer viewing.

When the user selects button 402, the advertisement is designated as one that is to be viewed at some point in the future and placed into the deferred advertisement queue. The advertisement can then be immediately terminated and the multimedia content continues to play instead. The deferred advertisement queue may maintain the actual advertisement in local storage on the computing device. Alternately, the deferred advertisement queue may maintain a link to the advertisement instead. The link can be later used to access the advertisement when the user wishes to view the advertisement. For example, the advertisement may be stored remotely at a cloud-based advertisement server. The link can be used to retrieve the advertisement from the advertisement server.

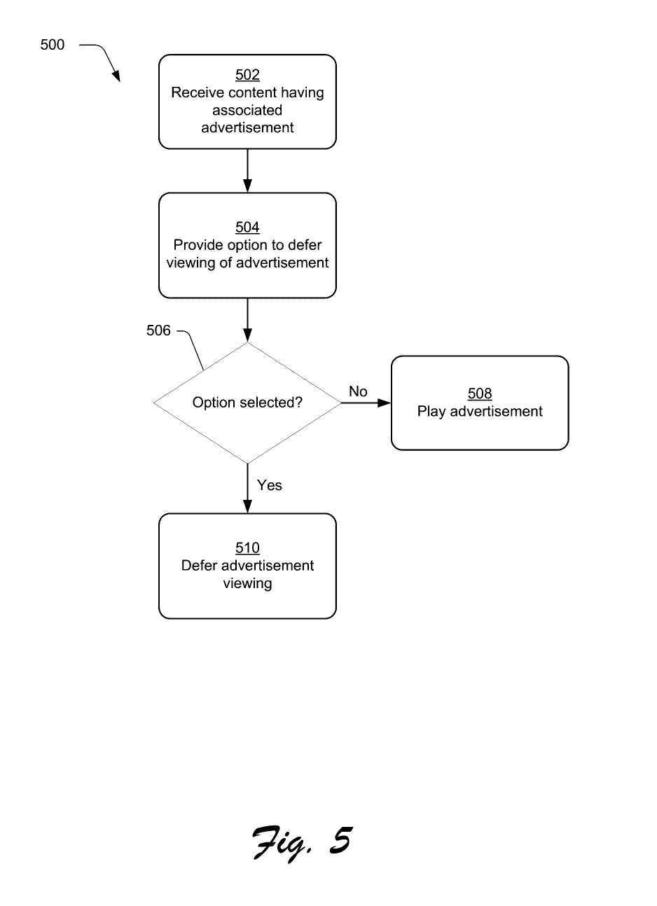

FIG. 5 describes an example procedure 500 for deferring viewing of an advertisement. Aspects of the procedure may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures may be performed in a digital medium environment by a suitably configured device, such as the example computing device 102 of FIG. 1 that makes use of an advertising workflow application 109, such as that described above.

At block 502, content is received having an associated advertisement or advertisements. In some implementations, the content is received from a content publisher and the advertisement or advertisements are received from a separate advertisement server. In other implementations, the content and advertisements are received from a common source. Any suitable type of content can be received, examples of which are provided above. At block 504, an option is provided to the user to defer viewing of the advertisement until a later time. This operation can be performed in any suitable way. For example, in some implementations a user interface instrumentality can be provided, before the advertisement is played, to enable the user to defer viewing of the advertisement. Alternately, the advertisement can be played and, contemporaneously, a user interface instrumentality can be provided to enable the user to defer viewing of the advertisement.

At block 506, a determination is made as to whether the defer option has been selected. If the defer option has not been selected, the advertisement is played in the usual way (block 508). This operation can be performed in any suitable way. For example, in implementations in which the user is provided the option before the advertisement is played, this option can be performed by beginning to play the advertisement. This can include contacting an advertisement server to retrieve the advertisement or initiating play of any advertisement that accompanied the content. Alternately, if the advertisement was initially played, this operation can be performed by allowing the advertisement to continue to play. If, on the other hand, the defer option has been selected, at block 510, advertisement viewing is deferred. This operation can be performed in any suitable way. For example, the advertisement or an associated representation of the advertisement, such as a link, can be placed in the deferred advertisement queue. In addition, a notification associated with the advertisement can be placed into the computing device's notification panel. Alternately or additionally, the notification can be associated with the application that would normally play the associated advertisement, such as a video player application. In this manner, the next time the user launches the video player application, the user can be prompted to view the advertisements that have been associated with the video player application.

Having considered how advertisement viewing can be deferred, consider now some different types of notifications that can be utilized in conjunction with deferred advertisement viewing.

Cancellable and Non-Cancellable Notifications

In one or more implementations, different types of notifications can be utilized. The different types of notifications can include, by way of example and not limitation, cancelable notifications and non-cancelable notifications.

A cancelable notification is one that has a visual representation that is placed into the notification panel. The visual representation, however, can be visually hidden by the user. That is, by selecting a particular user interface instrumentality, the visual representation of the notification can be cleared. When a notification is cleared from the notification panel, the associated advertisement still remains in the deferred advertisement queue if the advertisement has not been viewed.

A non-cancelable notification is a notification whose visual representation cannot be visually hidden by the user. This means that the non-cancelable notification serves as a continuous visual reminder to the user that one or more advertisements reside in the deferred advertisement queue and remain to be viewed.

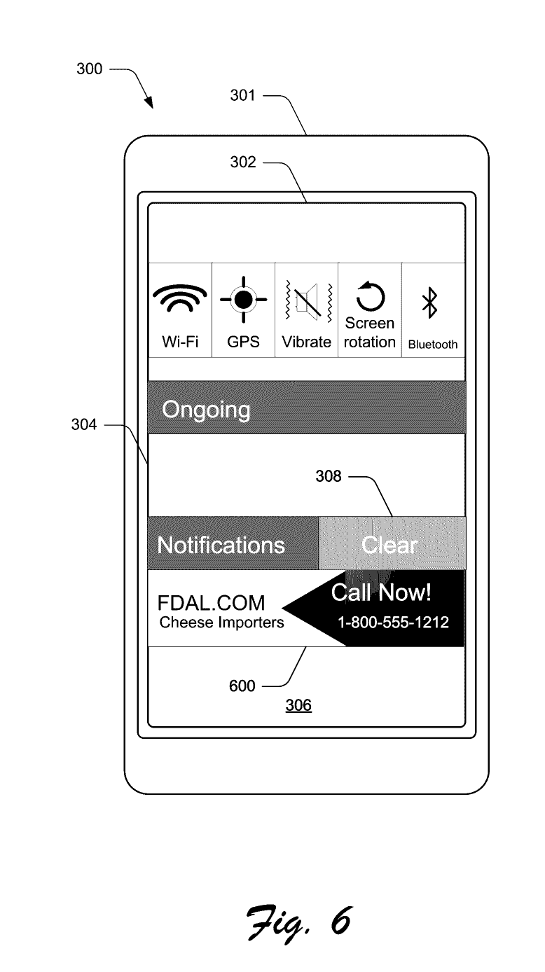

Recall from the FIG. 4 example, an advertisement from “FDAL Cheese Importers” was received and play was initiated. In addition, the user opted to defer viewing of the advertisement by selecting button 402. By selecting the deferral button, a notification can be prepared and placed into the notification panel. As an example, consider FIG. 6 which uses like numerals from FIG. 3.

There, a notification 600 has been placed into cancelable notification area 306. The notification includes information associated with the advertisement whose viewing has been deferred. In this particular example, the notification includes a title and some contact information that appears in a banner. By virtue of appearing in the cancelable notification area, the notification can be visually cleared by selecting button 308. In addition to providing the notification, an entry associated with the deferred advertisement can be placed into the deferred advertisement queue. The entry can include the advertisement itself Alternately, the entry can include a link to the advertisement. Once the advertisement has been viewed by the user, the advertising server can be notified that the advertisement has been viewed so that the appropriate advertisement viewing metrics can be updated. In either case—where the entry is the advertisement itself, or the entry is a link to the advertisement—the advertising server will consider the advertisement as viewed only after the advertisement is viewed—not when it is downloaded. The advertising server will know this by virtue of the video player pinging the tracking URLs at the appropriate time during the user's advertisement viewing.

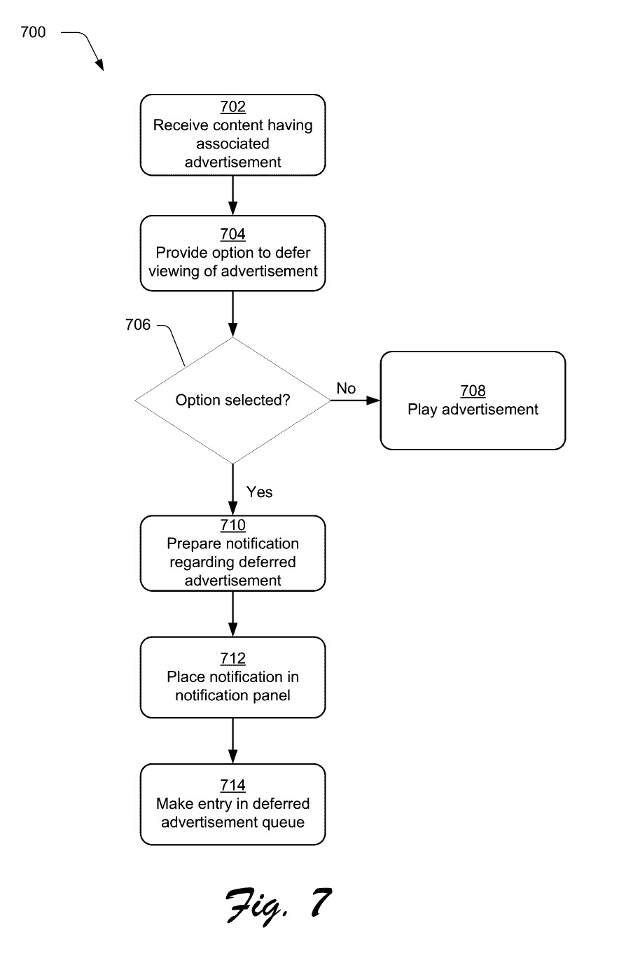

FIG. 7 describes an example procedure 700 for deferring viewing of an advertisement. Aspects of the procedure may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures may be performed in a digital medium environment by a suitably configured device, such as the example computing device 102 of FIG. 1 that makes use of an advertising workflow application 109, such as that described above.

At block 702, content is received having an associated advertisement or advertisements. In some implementations, the content is received from a content publisher and the advertisement or advertisements are received from a separate advertisement server. In other implementations, the content and advertisements are received from a common source. Any suitable type of content can be received, examples of which are provided above. At block 704, an option is provided to the user to defer viewing of the advertisement until a later time. This operation can be performed in any suitable way. For example, in some implementations a user interface instrumentality can be provided, before the advertisement is played, to enable the user to defer viewing of the advertisement. Alternately, the advertisement can be played and, contemporaneously, a user interface instrumentality can be provided to enable the user to defer viewing of the advertisement.

At block 706, a determination is made as to whether the defer option has been selected. If the defer option has not been selected, the advertisement is played in the usual way (block 708). This operation can be performed in any suitable way. For example, in implementations in which the user is provided the option before the advertisement is played, this option can be performed by beginning to play the advertisement. This can include contacting an advertisement server to retrieve the advertisement or initiating play of any advertisement that accompanied the content. Alternately, if the advertisement was initially played, this operation can be performed by allowing the advertisement to continue to play. If, on the other hand, the defer option has been selected, at block 710 a notification regarding the deferred advertisement is prepared. Any suitable type of notification can be prepared, an example of which is provided above. At block 712, the notification is placed in a notification panel associated with the computing device that received the content and advertisement. In at least some implementations, the notification can be placed in a cancelable notification area within the notification panel. At block 714, an entry that represents the advertisement is made in a deferred advertisement queue. The entry can comprise the advertisement itself which may be stored locally. Alternately, the entry can comprise some other object such as a link to the advertisement, and the like.

By deferring advertisement viewing, a user is able to conveniently view content in a generally uninterrupted manner. In a sense, viewing deferral represents a contract between the user and the advertiser. In return for being able to view their content in a generally uninterrupted manner by deferring advertisement viewing, the user agrees to watch the advertisement at some time in the future. However, in some instances the deferred advertisement queue may come to hold a large number of deferred advertisements. In some implementations, measures may be taken to attempt to ensure that the number of deferred advertisements maintained in the deferred advertisement queue does not grow too large.

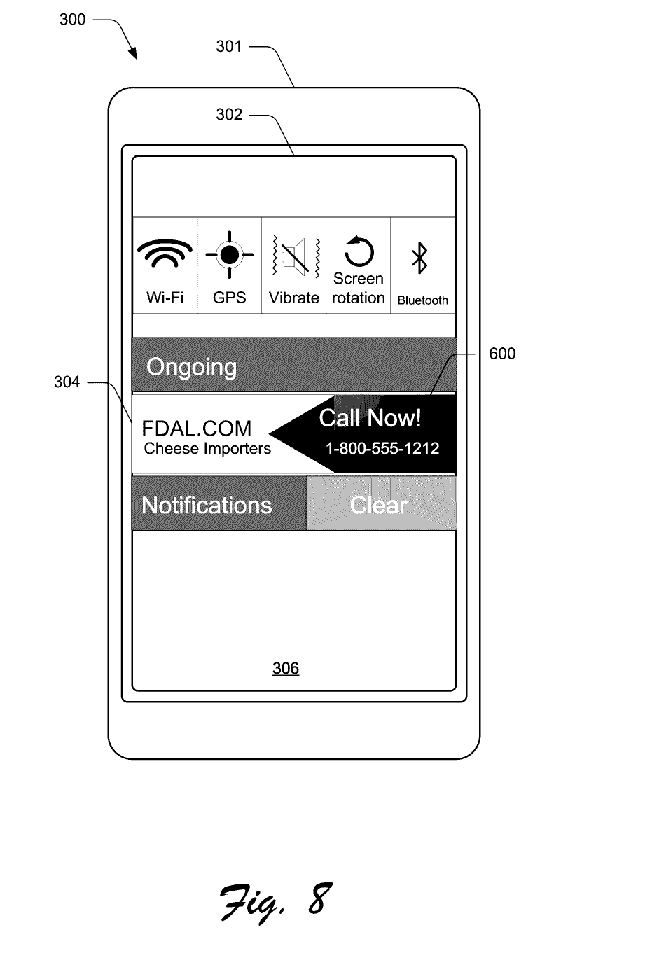

In some implementations, if the number of cancelable notifications reaches a certain threshold, then one or more of the cancelable notifications can be designated as non-cancelable notifications and added to the non-cancelable notification area of the user interface. For example, in some implementations, if the threshold is reached, all subsequent notifications can be placed in the non-cancelable notification area. Alternately, if the threshold is reached, all of the cancelable notifications can be placed in the non-cancelable notification area. The non-cancelable notification area displays notifications that cannot be visually hidden by the user. In some implementations, depending on the device form factor, the non-cancelable notifications can be cycled through the user interface as by being displayed in a repeated pattern. For example, each non-cancelable notification might be cycled through and displayed for five seconds. By virtue of being a non-cancelable notification, the user is provided with a continuous visual reminder that there are a number of advertisements that need to be viewed. As an example, consider FIG. 8.

There, the notification 600 has been relocated from cancelable notification area 306 to non-cancelable notification area 304. In some implementations, the user may still be permitted to view content when the number of non-cancelable notifications does not exceed a defined threshold.

In some implementations, management of the number of advertisements in the deferred advertisement queue can include ensuring that the number of notifications in the non-cancelable notification area does not exceed a certain threshold. In these instances, the number of notifications in the cancelable notification area has grown to exceed a defined threshold and, the number of notifications in the non-cancelable notification area has grown to exceed a corresponding defined threshold. The thresholds can be set by the advertisement workflow application 109 through the application provider. The application provider can be, by way of example and not limitation, a third party stand-alone application provider, a video player provider, and the like. In some implementations, when the threshold for the non-cancelable notification area has been exceeded, the option to defer advertisement viewing can be removed so that the user is no longer able to defer viewing. This can be accomplished by removing the user interface instrumentality that enables the user to select viewing deferral. When this occurs, any subsequently-received content may not be viewed without first viewing the accompanying advertisements. In addition, the user can be notified that the non-cancelable notification threshold has been met and can be provided with an option to view advertisements in the deferred advertisement queue. In some implementations, advertisers can agree in advance to allow their advertisements to be deferred in the manner described above. When agreed to in advance, the video player application (which includes an advertisement workflow application) or a standalone advertisement workflow application can enforce the above-described functionality.

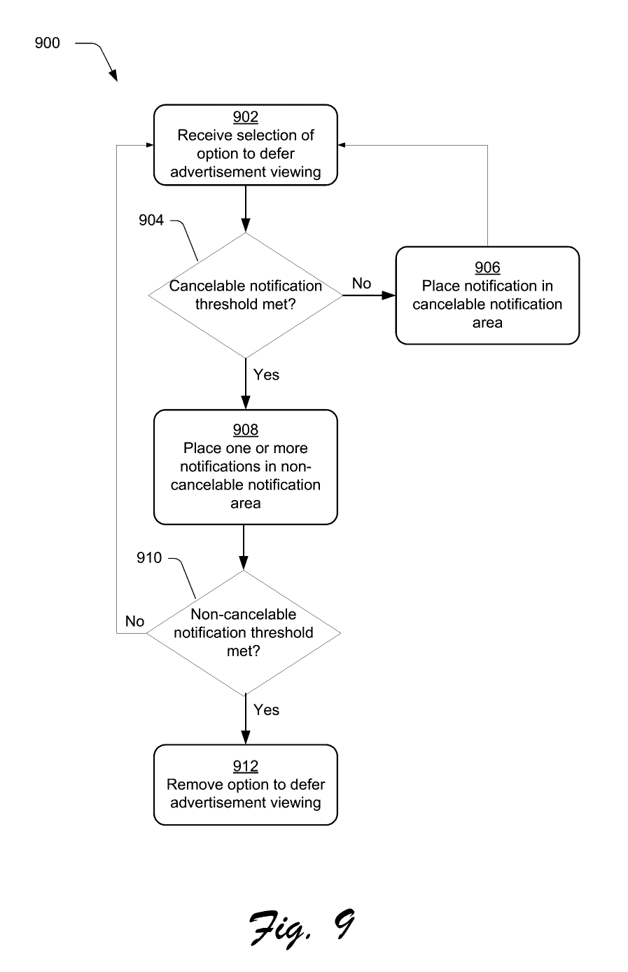

FIG. 9 describes an example procedure 900 for managing the deferred advertisement queue. Aspects of the procedure may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures may be performed in a digital medium environment by a suitably configured device, such as the example computing device 102 of FIG. 1 that makes use of an advertising workflow application 109, such as that described above.

At block 902 selection of an option to defer advertisement viewing is received. Examples of how this can be done are provided above. At block 904, a determination is made as to whether a cancelable notification threshold is met. If the threshold is not met, a notification associated with the viewing-deferred advertisement is placed in a cancelable notification area of a user interface (block 906) and the procedure returns to block 902. If, on the other hand, the cancelable notification threshold is met, at block 908 one or more notifications are placed in a non-cancelable notification area of a user interface. This operation can be performed by placing all of the notifications in the cancelable notification area in the non-cancelable notification area. Alternately, this operation can be performed by placing the current notifications and all subsequent notifications in the non-cancelable notification area. At block 910, a determination is made as to whether the non-cancelable notification threshold is met. If the threshold is not met, then the procedure returns to block 902. If, on the other hand, the non-cancelable notification threshold is met, the option to defer advertisement viewing is removed (block 912). This operation can be performed in any suitable way. For example, in at least some implementations this operation can be performed by removing the user interface instrumentality that allows the user to defer advertisement viewing. In addition, the user may be prompted to view one or more of the advertisements that reside in the deferred advertisement queue.

Having considered aspects of cancelable and non-cancelable notifications, consider now aspects of viewing the deferred advertisements and other management aspects.

Viewing Deferred Advertisements and Other Management Aspects

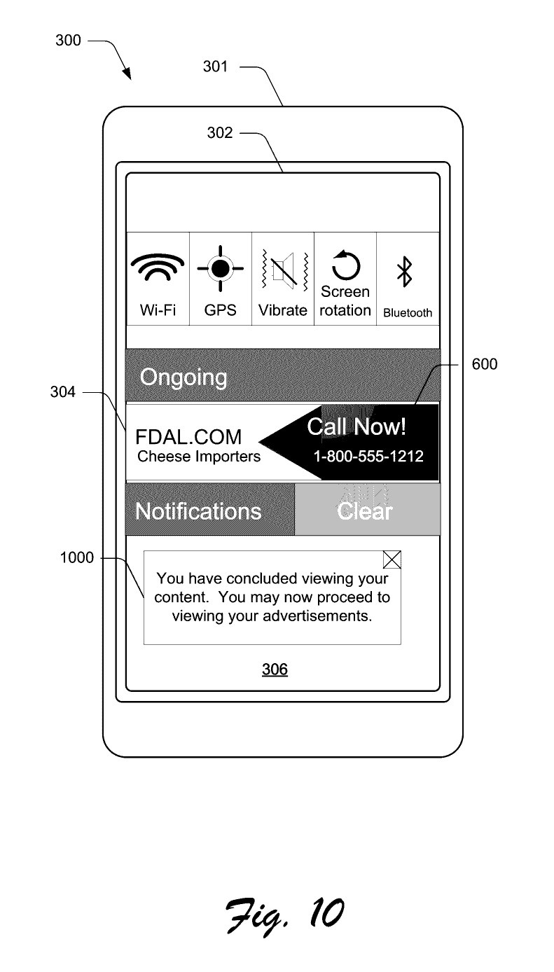

In some implementations in which the user has deferred viewing one or more advertisements in favor of consuming their content, upon concluding their content viewing, the user can be prompted to view the advertisements that are saved in the deferred advertisement queue. As an example, consider FIG. 10 which illustrates the digital medium environment of FIG. 3, wherein like numerals are utilized. Notice that a prompt 1000 appears in the user interface and indicates to the user that they may now proceed to view their advertisements. To view the advertisements, the user simply needs to select them from the notification panel. In this particular example, the user can select from either the non-cancelable notification area 304 or the cancelable notification area 306. They may do this in any suitable way such as by tapping or otherwise selecting a notification. When this happens, the video player application that pushed the notification is launched and the application plays the video advertisement. If the advertisement is stored locally, the advertisement can be retrieved and played. If, on the other hand, the advertisement is stored remotely, such as by a remote advertisement server, the application can contact the server to retrieve the advertisement. The video player service can also notify the advertising server about the ad click and the web browser can be redirected to the advertiser's ad click link to display the advertisement. In various implementations, each advertisement that has been deferred needs to be watched, even if the same advertisement has been deferred two or more times for different respective videos. The advertisement can then be removed from the deferred advertisement queue. Once the advertisement has been viewed, it will be removed from the notification panel and also from the deferred advertisement queue. The user can also be prompted at other times to view their deferred advertisements. For example, the user may be periodically prompted on a regular basis. Alternately or additionally, the user might be prompted when the number of deferred advertisements in the notification panel reaches a certain threshold.

In some implementations, the state of the notification panel and deferred advertisement queue is maintained across device restarts and video player restarts. That is, if multiple advertisements reside in the notification panel and deferred advertisement queue and the video player is closed or the device is restarted, those advertisements will still reside in the notification panel and the deferred advertisement queue. In this manner, the user will still be committed to watching the advertisements even though they restarted their video player or device. When the user restarts their device or video player, if the user does not select any ads in the notification panel, the user can be given an option to watch a few or all of the deferred advertisements just before the next content starts. In these instances, a prompt similar to the one in FIG. 10 might be used. Such prompt might state “Welcome back! Would you like to view your deferred advertisements now?” Once the user views a few advertisements, the advertisements in the deferred advertisement queue will be reduced and he or she will be allowed to watch the next content.

Different Advertising Models

In one or more implementations, an advertising model can be built around the deferred viewing feature described above and the “skip” button feature which allows a user to skip an advertisement altogether. That is, there may be instances where advertisers may place more importance on a particular advertisement and, therefore, wish for end users to view the advertisement. In this case, the advertiser may be charged a higher fee in order to select the deferred viewing feature for their advertisement rather than the skip button feature.

Having considered the above implementations, consider now an example system and device that can be utilized to practice the inventive principles described herein.

Example System and Device

FIG. 11 illustrates an example system generally at 1100 that includes an example computing device 1102 that is representative of one or more computing systems and/or devices that may implement the various techniques described herein. This is illustrated through inclusion of the applications 108 and, in particular, advertising workflow application 109, which operates as described above. The computing device 1102 may be, for example, a server of a service provider, a device associated with a client (e.g., a client device), an on-chip system, and/or any other suitable computing device or computing system.

The example computing device 1102 is illustrated includes a processing system 1104, one or more computer-readable media 1106, and one or more I/O interface 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1106 is illustrated as including memory/storage 1112. The memory/storage 1112 represents memory/storage capacity associated with one or more computer-readable media. The memory/storage component 1112 may include volatile media (such as random access memory (RAM)) and/or nonvolatile media (such as read only memory (ROM), Flash memory, optical disks, magnetic disks, and so forth). The memory/storage component 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device implementation, implementation of functionality described herein may be distributed throughout the system 1100. For example, the functionality may be implemented in part on the computing device 1102 as well as via the platform 1116 that abstracts the functionality of the cloud 1114.

Conclusion

Various implementations provide improved advertisement workflow techniques designed to increase click-through rates in the context of a digital medium environment. When content, such as streaming video, is received and has an associated advertisement, an option can be provided to enable the user to defer viewing of the advertisement. If the user selects the defer viewing option, the advertisement is placed in a deferred advertisement queue for later viewing and the user can proceed directly to consuming their content. The user can then choose to view deferred advertisements at any time that is convenient to the user.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment including a computing device having an advertising workflow application that performs advertisement workflow management, an improved advertising workflow method implemented by the computing device, the method comprising:
receiving, by the computing device, content having an associated advertisement;
providing, by the computing device, an option to defer viewing of the advertisement until a later time; and
responsive to determining that the option to defer viewing of the advertisement has been selected, deferring, using the computing device, viewing of the advertisement.

2. A method as described in claim 1, wherein said providing is performed by providing a selectable user interface instrumentality, before the advertisement is played, to enable the user to defer viewing of the advertisement.

3. A method as described in claim 1, wherein said providing is performed by providing a selectable user interface instrumentality contemporaneously with playing the advertisement, to enable the user to defer viewing of the advertisement.

4. A method as described in claim 1, wherein said deferring viewing is performed by placing the advertisement in a deferred advertisement queue.

5. A method as described in claim 1, wherein said deferring viewing is performed by placing a link associated with the advertisement in a deferred advertisement queue.

6. A method as described in claim 1, wherein said deferring viewing is performed by placing a notification associated with the advertisement into a notification panel of the computing device.

7. A method as described in claim 1, wherein said deferring viewing is performed by associating a notification with an application that is configured to play the advertisement.

8. In a digital medium environment in which a computing device can use an advertising workflow application to perform advertisement workflow management, one or more computer-readable storage media comprising instructions that are stored thereon that implement the advertising workflow application which, responsive to execution by the computing device, perform improved advertising workflow operations comprising:
receiving content having an associated advertisement;
providing an option to defer viewing of the advertisement until a later time;
responsive to determining that the option to defer viewing of the advertisement has been selected, deferring viewing of the advertisement by:
preparing a notification associated with the advertisement to be deferred;
placing the notification in a notification panel associated with the computing device; and
making an entry that represents the advertisement in a deferred advertisement queue.

9. The one or more computer-readable storage media as described in claim 8, wherein the notification panel includes:
a cancelable notification area within which visual representations of notifications can be visually hidden, and
a non-cancelable notification area in which visual representations of notifications cannot be visually hidden; and
wherein said placing the notification comprises placing the notification in the cancelable notification area.

10. The one or more computer-readable storage media as described in claim 8, wherein the notification panel includes:
a cancelable notification area within which visual representations of notifications can be visually hidden, and
a non-cancelable notification area in which visual representations of notifications cannot be visually hidden; and
wherein the notification panel is configured to enable visual representations of notifications to be moved from the cancelable notification area to the non-cancelable notification area.

11. The one or more computer-readable storage media as described in claim 8, wherein said providing is performed by providing a selectable user interface instrumentality, before the advertisement is played, to enable the user to defer viewing of the advertisement.

12. The one or more computer-readable storage media as described in claim 8, wherein said providing is performed by providing a selectable user interface instrumentality contemporaneously with playing the advertisement to enable the user to defer viewing of the advertisement.

13. The one or more computer-readable storage media as described in claim 8, the operations further comprising removing the option to defer viewing of an advertisement based, at least in part, on the number of advertisements that have been deferred.

14. A system implemented in a digital medium environment including a computing device having an advertising workflow application to perform advertisement workflow management, the system comprising:
a processing system;
one or more computer readable media storing instructions executable via the processing system to implement an advertising workflow application configured to perform operations comprising:
receiving selection of an option to defer viewing of an advertisement that is associated with content that is to be consumed on the computing device;
determining whether a cancelable notification threshold is met, the cancelable notification threshold pertaining to notifications that serve as a reminder that advertisement viewing has been deferred, wherein cancelable notifications can be visually hidden by a user;
responsive to the cancelable notification threshold not being met, placing a notification associated with the advertisement in a cancelable notification area of a user interface; and
responsive to the cancelable notification threshold being met, placing one or more notifications in a non-cancelable notification area of the user interface, wherein the non-cancelable notifications cannot be visually hidden by a user.

15. The system as described in claim 14, wherein the operations further comprise determining whether a non-cancelable notification threshold is met; and
responsive to the non-cancelable notification threshold being met, removing the option to defer viewing of an advertisement.

16. The system as described in claim 15, wherein removing the option to defer viewing of an advertisement comprises removing a user interface instrumentality that allows a user to defer advertisement viewing.

17. The system as described in claim 15 further comprising prompting the user to view advertisements that are saved in a deferred advertisement queue.

18. The system as described in claim 15 further comprising prompting the user to view advertisements that are saved in a deferred advertisement queue when the computing device is started.

19. The system as described in claim 15 further comprising prompting the user to view advertisements that are saved in a deferred advertisement queue when a video player application is started.

20. The system as described in claim 15, further comprising prompting a user to view advertisements that are saved in a deferred advertisement queue; and, responsive to a user viewing one or more advertisements, removing the one or more advertisements from the deferred advertisement queue and allowing the user to consume content.
